(19) United States
(12) Patent Application Publication
(10) Pub. No.: US 2008/0248943 A1
(43) Pub. Date: Oct. 9, 2008

(54) Method of Regenerating Thermally Deteriorated Catalyst

(75) Inventors: Atsushi Fukuju, Hiratsuka-shi (JP); Masayoshi Ichiki, Sakai-shi (JP); Kazuhiro Yano, Osaka-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: HITACHI ZOSEN CORPORATION

(21) Appl. No.: 10/572,310

(22) PCT Filed: Sep. 21, 2004
(86) PCT No.: PCT/JP2004/014131

§ 371 Date: Mar. 17, 2006

(30) Foreign Application Priority Data
Sep. 18, 2003 (JP) 2003-325665

(51) Int. Cl. B01J 38/68

(52) U.S. Cl. 502/24

(57) ABSTRACT

A catalyst that is used for a method of reduction removal of NOₓ in a exhaust gas by using ammonia as a reducing agent and has been deteriorated in activity by aggregation of vanadium oxide as an active component through long term use at a high temperature is washed with an acid aqueous solution having pH of 6 or less, and preferably 4 or less. The washing operation dissolves and removes away mainly the vanadium oxide as the aggregated active component, and then vanadium oxide as the active component is re-deposited thereon. The method of the invention enables regeneration of a thermally deteriorated catalyst, which has conventionally been impossible. The washing operation with the acid aqueous solution or an alkali aqueous solution does not influence the mechanical strength of the catalyst.

### TECHNICAL FIELD

The present invention relates to a method for regenerating and reusing a thermally deteriorated catalyst. In general, when a denitration catalyst is used at a high temperature of 350° C. or more for a long period of time, vanadium oxide as an active component is aggregated to cause thermal deterioration. The invention relates to a method that enables regeneration of the thermally deteriorated catalyst.

The invention also relates to a method for regenerating a catalyst that is used for reduction removal of NOₓ in a coal-burning exhaust gas by using ammonia and has been deteriorated.

### BACKGROUND ART

Various proposals have been conventionally made for a regenerating method of a denitration catalyst having a titania carrier with vanadium, tungsten or the like carried thereon (see Japanese Patent No. 2,994,769, JP-A-11-057410, JP-A-2000-037634, JP-A-2000-037635, JP-A-10-235209, JP-A-10-066875, JP-A-07-222924, JP-A-06-099164, JP-A-10-337483, JP-A-10-156193, JP-A-10-156192, JP-A-2000-107612 and JP-A-2000-102737).

### DISCLOSURE OF THE INVENTION

All the regenerating methods dissolve and remove poisoning substances with an aqueous solution of an acid or an alkali, the dissolution capability of which for the poisoning substances has been known, to attempt restoration of the activity, and there is no description with respect to deterioration in activity caused by thermal sintering or aggregation.

Removal of calcium, which is insoluble in general to acid or alkali, is carried out by using hydrofluoric acid. In the treating method, the waste solution cannot be easily treated thereby to increase the cost for regeneration of the catalyst. There is such a proposal for regenerating a catalyst having been deteriorated due to poisoning with an arsenic compound that the catalyst is washed with an alkali aqueous solution and then activated with an acid aqueous solution, but it is not an effective method as shown in Comparative Example.

A first aspect of the invention is a method for regenerating a thermally deteriorated catalyst characterized by comprising steps of washing a catalyst that is used for reduction removal of NOₓ in a exhaust gas by using ammonia as a reducing agent and has been deteriorated in activity by aggregation of vanadium oxide as an active component through long term use at a high temperature with an acid aqueous solution having pH of 6 or less, and preferably 4 or less, so as to dissolve and remove away mainly vanadium oxide as an aggregated active component; and then re-depositing vanadium oxide as an active component thereon.

The acid used in the first method is preferably nitric acid or hydrochloric acid.

A second aspect of the invention is a method for regenerating a thermally deteriorated catalyst characterized by comprising steps of washing a catalyst that is used for reduction removal of NOₓ in a exhaust gas by using ammonia as a reducing agent and has been deteriorated in activity by aggregation of vanadium oxide as an active component through long term use at a high temperature with an alkali aqueous solution having pH of 8 or more, and preferably 10 or more, so as to dissolve and remove away mainly vanadium oxide and tungsten oxide as an active component; then re-depositing titanium oxide as a carrier component thereon; and then re-depositing vanadium oxide and tungsten oxide as an active component thereon.

The alkali used in the second invention is preferably aqueous ammonia.

A third aspect of the invention is a method for regenerating a deteriorated catalyst characterized by comprising steps of washing a catalyst that is used for reduction removal of NOₓ in a coal-burning exhaust gas by using ammonia as a reducing agent and has been deteriorated in activity with an acid aqueous solution having pH of 4 or less, and preferably 2 or less, so as to dissolve and remove away mainly an alkali metal, an alkaline earth metal, arsenic and sulfur, which are deteriorating components; then washing with an alkali aqueous solution having pH of 8 or more, and preferably 10 or more, so as to dissolve and remove away mainly vanadium oxide and tungsten oxide as an active component; and then re-depositing vanadium oxide and tungsten oxide as an active component thereon, followed by calcining. The alkali metal as a deteriorating component includes potassium, sodium and the like, and the alkaline earth metal includes calcium, magnesium and the like.

In the third invention, it is preferred that a water washing step is inserted among the acid treating step, the alkali treating step and the active component re-depositing step.

The acid used in the third invention is preferably nitric acid or hydrochloric acid, and the alkali used herein is preferably aqueous ammonia.

The first and second inventions will be described.

As a result of investigation of a thermally deteriorated catalyst, the following has been found.

Deterioration of the catalyst activity is mainly caused by aggregation of a vanadium oxide deposited on titania, and the decrease in specific surface area of the titania until a certain threshold value (60 m²/g) has no relationship to the deterioration in activity (see FIG. 1). It has been found accordingly that the thermally deteriorated catalyst of this type can be substantially completely regenerated in catalyst activity by removing the aggregated vanadium oxide and newly re-depositing vanadium thereon.

In the case where the specific surface area of the titania decreases below the threshold value (60m²/g), the deterioration in activity is the sum of the deterioration due to aggregation of vanadium oxide and deterioration due to aggregation of titania. It has been found that the thermally deteriorated catalyst of this type can be substantially completely regenerated in catalyst activity by removing vanadium oxide and tungsten oxide as an active component, then re-depositing titania as a carrier component thereon, and then newly re-depositing vanadium oxide and tungsten oxide thereon.

As a result of investigation on dissolution removal of vanadium oxide and tungsten oxide based on the findings, the following knowledge has been obtained.

(1) Vanadium oxide and tungsten oxide deposited on the surface of the catalyst exhibit such dissolution property that is different from those solely existing.

(2) The dissolution property of vanadium oxide and tungsten oxide deposited on the surface of the catalyst depends only on the pH of the solution irrespective of the kind of the acid or alkali, in which a higher pH can dissolve vanadium oxide and tungsten oxide simultaneously, and a low pH dissolves mainly vanadium oxide.

The knowledge is shown in FIGS. 2 and 3.

The first and second inventions are novel methods for regenerating a deteriorated catalyst obtained by combining the aforementioned knowledge. A deteriorated catalyst is immersed in a solution (an acid aqueous solution) having a pH of 6 or less, and preferably 4 or less, for 2hours or more, and preferably 4 hours or more, so as to dissolve and remove away mainly vanadium oxide deposited on the catalyst. According to the operation, the active component having been decreased in activity due to aggregation can be removed. The specific surface area of the titania carrier having been decreased cannot be restored, but in the case where the specific surface area after deterioration is 60 m²/g or more, the activity can be restored in substantially 100% by re-depositing an active component thereon. In the case where the specific surface area after deterioration is 60 m²/g or less, the catalyst is immersed in a solution (an alkali aqueous solution) having a pH of 8 or more, and preferably 10 or more, for 2 hours or more, and preferably 4 hours or more, so as to dissolve and remove away mainly vanadium oxide and tungsten oxide deposited on the catalyst, then titania is re-deposited thereon, and then an active component is re-deposited thereon, whereby the activity can be restored in substantially 100%. The acid for maintaining the pH value is preferably a mineral acid other than sulfuric acid, particularly nitric acid and hydrochloric acid. The alkali is preferably aqueous ammonia. This is because they exhibit substantially no influence on the activity due to substances remaining on the surface of the catalyst.

The third invention will be described.

A catalyst that is used for reduction removal of NOₓ in a coal-burning exhaust gas by using ammonia and has been deteriorated in activity is washed with an acid aqueous solution having pH of 4 or less, and preferably 2 or less, so as to dissolve and remove away mainly calcium, potassium, sodium, arsenic and sulfur, which are deteriorating components. Furthermore, a catalyst that has vanadium oxide and tungsten oxide as a catalyst active component having been chemically deteriorated in activity is washed with an alkali aqueous solution having pH of 8 or more, and preferably 10 or more, so as to dissolve and remove away vanadium oxide and tungsten oxide as an active component. Subsequently, vanadium oxide and tungsten oxide as an active component is re-deposited thereon followed by calcination.

As a result of investigation on a dissolution and removal method of calcium, potassium, arsenic and sulfur, the following knowledge has been obtained.

(1) The dissolution property of calcium, potassium, arsenic and sulfur accumulated on the surface of the catalyst depends only on the pH of the solution irrespective to the kind of the acid.

(2) Calcium, potassium, arsenic and sulfur accumulated on the surface of the catalyst can be simultaneously removed by washing with an acid aqueous solution.

The knowledge is shown in FIGS. 6 and 8.

In the case where the order of the washing operations with an acid aqueous solution and an alkali aqueous solution is inverted, no sufficient regeneration effect is obtained. In the case where the washing operation with an alkali aqueous solution is firstly carried out, sulfur and the like in the catalyst is dissolved out to decrease the pH, whereby vanadium oxide and tungsten oxide having been chemically deteriorated in activity cannot be sufficiently dissolved. Furthermore, calcium and the like, which are not dissolved with an alkali aqueous solution but remain in the catalyst, hinder vanadium oxide and tungsten oxide from being dissolved. It is important in the regenerating method that the washing operation with an acid aqueous solution is firstly carried out to dissolve oxides of calcium, potassium, arsenic and sulfur, which are deteriorating components, and then the washing operation with an alkali aqueous solution is carried out to dissolve vanadium oxide and tungsten oxide, and if the order is inverted, vanadium oxide and tungsten oxide having been chemically deteriorated in activity cannot be sufficiently dissolved.

Accordingly, many kinds of deteriorated catalysts can be regenerated by washing with an acid aqueous solution and then washing with an alkali aqueous solution. In the case where catalyst powder is dispersed and retained in ceramics paper, since no binder is used, the washing operations with an acid aqueous solution and an alkali aqueous solution do not dissolve a binder or the like without influence on the mechanical strength of the catalyst.

The third invention is a novel method for regenerating a deteriorated catalyst developed by combining the aforementioned knowledge.

A catalyst having been deteriorated in activity is washed by immersing in an acid aqueous solution having pH of 4 or less, and preferably 2 or less, for 2 hours or more, and preferably 4 hours or more, so as to dissolve and remove away mainly calcium, potassium, sodium, arsenic and sulfur, which are deteriorating components. Furthermore, a catalyst that has vanadium oxide and tungsten oxide as a catalyst active component having been chemically deteriorated in activity is washed with an alkali aqueous solution having pH of 8 or more, and preferably 10 or more, so as to dissolve and remove away vanadium oxide and tungsten oxide as an active component. Subsequently, vanadium oxide and tungsten oxide as an active component is re-deposited thereon followed by calcination.

The acid for maintaining the pH value is preferably a mineral acid other than sulfuric acid, particularly nitric acid and hydrochloric acid. The alkali is preferably aqueous ammonia. This is because they exhibit substantially no influence on the activity due to substances remaining on the surface of the catalyst.

According to the first and second inventions, a thermally deteriorated catalyst can be regenerated, which has conventionally been impossible. The washing operations with an acid aqueous solution and an alkali aqueous solution are excellent measures without influence on the mechanical strength of the catalyst.

According to the third invention, many kinds of deteriorated catalysts can be regenerated by washing with an acid aqueous solution and then washing with an alkali aqueous solution. Since no binder or the like is used in the catalyst, the washing operations with an acid aqueous solution and an alkali aqueous solution do not dissolve a binder or the like without influence on the mechanical strength of the catalyst.

### BRIEF DESCRIPTION OF THE DRAWINGS

FIG. 1 is a graph showing deterioration characteristics of catalyst activity.

FIG. 2 is a graph showing relationship between the kind of the washing solution and the dissolution property of vanadium oxide and tungsten oxide.

FIG. 3 is a graph showing relationship between the pH of the washing solution and the dissolution property of vanadium oxide and tungsten oxide.

FIG. 4 is a graph showing the performance of the catalyst before and after regeneration.

FIG. 5 is a graph showing the performance of the catalyst having vanadium oxide and tungsten oxide re-deposited before and after regeneration.

FIG. 6 is a graph showing relationship between the pH of the washing solution and the dissolution property of calcium and potassium.

FIG. 7 is a graph showing the performance of the catalyst having vanadium oxide and tungsten re-deposited before and after regeneration.

FIG. 8 is a graph showing relationship between the pH of the washing solution and the dissolution property of an arsenic oxide and a sulfur oxide.

FIG. 9 is a graph showing the performance of the catalyst after regenerating an arsenic deteriorated catalyst.

FIG. 10 is a graph showing the performance of the catalyst having vanadium oxide and tungsten re-deposited.

FIG. 11 is a graph showing the performance of the catalyst having vanadium oxide and tungsten re-deposited in Comparative Example 1.

### BEST MODE FOR CARRYING OUT THE INVENTION

The invention will be specifically described with reference to the following examples.

### EXAMPLE 1

### (1) Thermal Deterioration

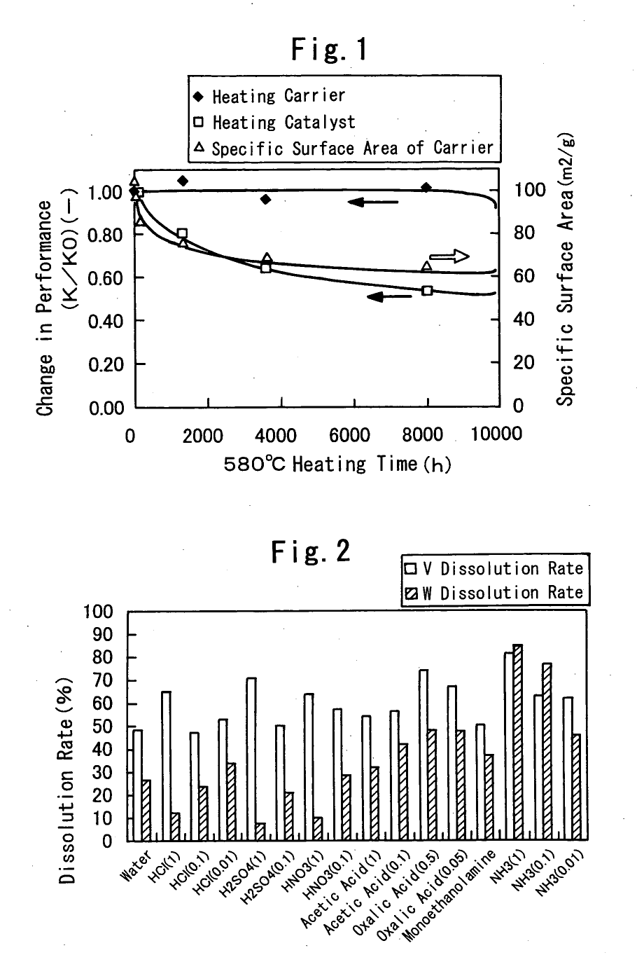

75 g/m² of anatase TiO₂ fine powder was dispersed and retained on ceramics paper (thickness: 0.3 mm nominal value) to form a plate carrier precursor (specific surface area: 105 m²/g) (hereinafter, referred to as a carrier precursor), which was calcined at 580° C. for various periods of time to prepare carriers having various specific surface areas. The carriers were immersed in a 0.03 mol/L ammonium metavanadate (NH₄VO₃) aqueous solution for30 minutes, followed by drying and calcining, to adsorb and deposit vanadium oxide thereon. Subsequently, they were immersed in a 15% by weight WO₃ aqueous solution for 30 minutes, followed by drying and calcining, to prepare denitration catalysts. The catalysts were measured for denitration performance. The results are shown in FIG. 1. It is understood from FIG. 1 that the denitration performance is substantially constant in the case where the specific surface area of the carrier is 60 m²/g or more.

Vanadium oxide and tungsten oxide were deposited on the carrier precursor under the same conditions as above, and then it was calcined at 580° C. for various periods of time to prepare thermally deteriorated catalysts having various specific surface areas. The performances of the catalysts are also shown in FIG. 1.

The performance of a catalyst is defined by the ratio K/K₀, in which assuming that the denitration reaction is a first-order reaction of NOₓ, K represents the reaction rate constant at 350° C. where the ratio NOₓ/NH₃=1.0 (K=−(AV)ln(1−x), wherein AV represents an amount of a exhaust gas per geometric surface area of the catalyst, and x represents the denitration rate), and K₀ represents the initial reaction rate constant having not been subjected to deterioration by firing at 580° C. Therefore, K/K₀=1 in the initial state.

The difference in performance change characteristics between the catalysts well suggests that thermal deterioration in activity is ascribed to aggregation of deposited vanadium oxide but not to decrease in specific surface area of the carrier.

### (2) Washing of Active Component

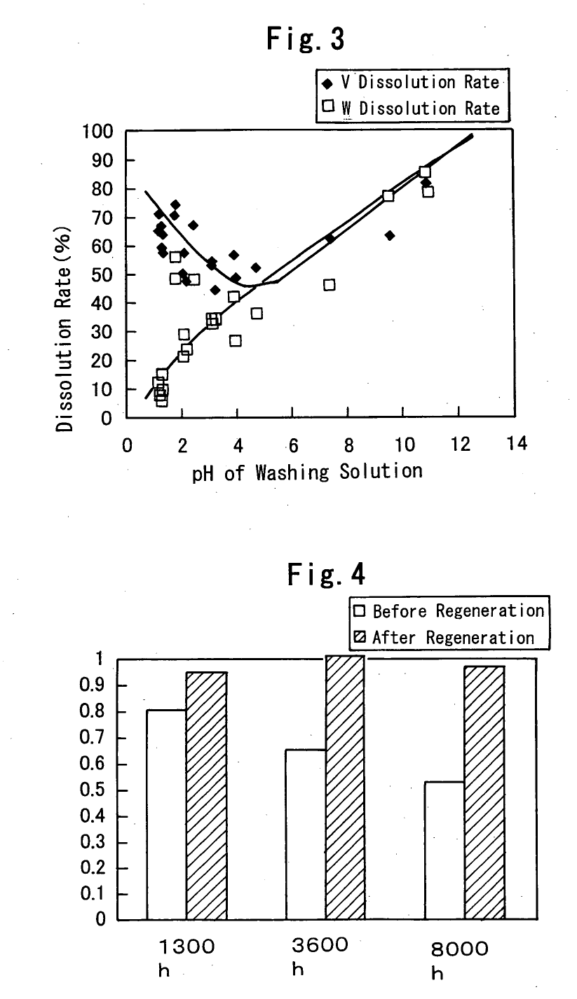

The thermally deteriorated catalyst shown in the aforementioned item (1) for thermal deterioration was immersed in various washing solutions for 5 hours, and dissolution property of vanadium oxide and tungsten oxide as an active component was observed. The results are shown in FIG. 2. The relationship between the hydrogen ion concentration (pH) of the washing solutions and the dissolution property is shown in FIG. 3.

In FIG. 2, numerals in parentheses are concentrations of an acid or an alkali (mol/L).

It is understood from the figures that the dissolution property of vanadium and tungsten depends only on the pH, in which a higher pH can dissolve vanadium and tungsten simultaneously, and a low pH dissolves mainly vanadium.

### (3 ) Regeneration of Thermally Deteriorated Catalyst

The thermally deteriorated catalyst shown in the aforementioned item (1) for thermal deterioration was immersed in a nitric acid aqueous solution having pH of 1.2 for 5 hours to dissolve and remove away vanadium oxide, and then vanadium oxide was again deposited under the same conditions, to prepare a catalyst, which was compared in performance. The results are shown in FIG. 4. Performances that were substantially the same as the initial performance were obtained.

The following knowledge was obtained from the results.

(1) The deterioration in activity of the catalyst is ascribed to aggregation of vanadium oxide deposited on the surface of titania.

(2) The decrease in specific surface area of the titania until a certain threshold value (60 m²/g) has no relationship to the deterioration in activity.

(3) In the case where vanadium is dissolved and removed away under the appropriate conditions, and then vanadium is re-deposited thereon, substantially complete catalyst regeneration can be carried out against thermal deterioration.

### (4) Compression Strength

The compression strengths of the catalyst before and after the catalyst regeneration shown in the aforementioned item (3) for the regeneration of the thermally deteriorated catalyst are shown in Table 1. It is understood from Table 1 that no decrease in compression strength is found after the catalyst regeneration. In Table 1, the compression strength ratio is a ratio (compression strength after regeneration)/(compression strength before regeneration).

TABLE 1
(Compression Strength Ratio)

| Calcining period at 580° C. (hr) | Compression strength ratio(−) |
|---|---|
| 1,300 | 1.01 |
| 3,600 | 0.98 |
| 8,000 | 1.00 |

### (5) Regeneration of Actually Thermally Deteriorated Catalyst

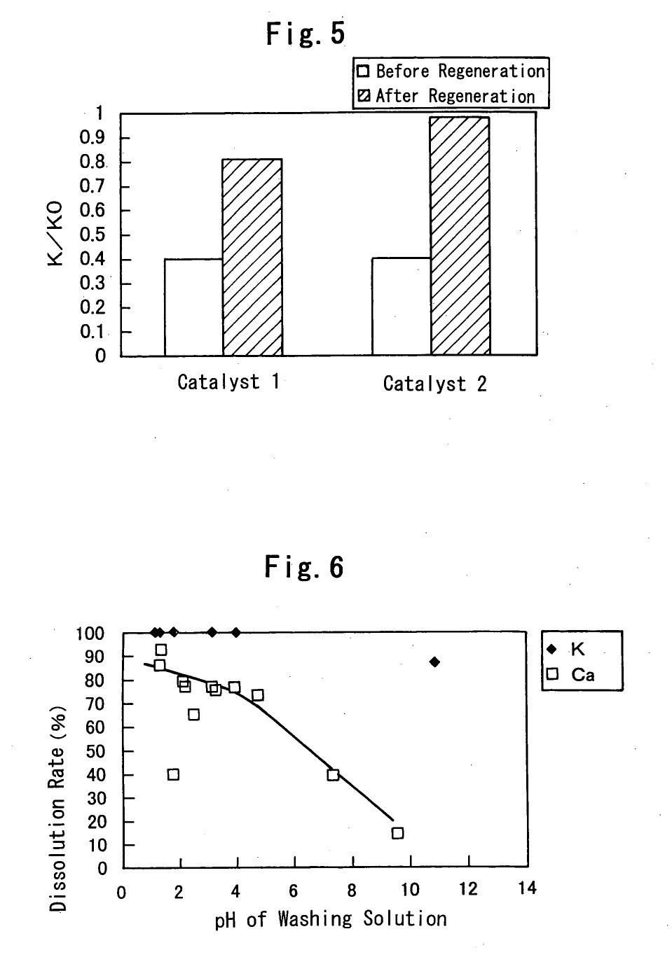

A thermally deteriorated catalyst (specific surface area of titania: 40 g/m²) in an active plant was immersed in a nitric acid aqueous solution having pH of 1.2 for 5 hours to dissolve and remove away vanadium, and then vanadium was re-deposited thereon. The catalyst was designated as a catalyst 1. A thermally deteriorated catalyst (specific surface area of titania: 40 g/m²) in an active plant was immersed in an NH₃ aqueous solution having pH of 10.5 for 5 hours to dissolve and remove away vanadium oxide and tungsten, and then vanadium oxide and tungsten were re-deposited thereon. The catalyst was designated as a catalyst 2. The catalyst 1 and the catalyst 2 were compared in performance. The results are shown in FIG. 5. It is understood from FIG. 5 that aggregation of titania as a carrier occurs simultaneously with aggregation of vanadium oxide, and the catalyst having been deteriorated in activity can be substantially restored to the initial performance by dissolving and removing away vanadium oxide and tungsten, then depositing titania, and then re-depositing vanadium oxide and tungsten thereon.

### EXAMPLE 2

### (1) Regeneration of Alkali-Deteriorated Catalyst

75 g/m² of anatase TiO₂ fine powder was dispersed and retained on ceramics paper (thickness: 0.3 mm nominal value) to form a plate carrier precursor (specific surface area: 105 m²/g), which was calcined at 500° C. for 1 hour to prepare a carrier. The carrier was immersed in a 0.03 mol/L ammonium metavanadate (NH₄VO₃) aqueous solution for 30 minutes, followed by drying and calcining, to adsorb and deposit vanadium oxide thereon. Subsequently, it was immersed in a 15% by weight WO₃ aqueous solution for 30 minutes, followed by drying and calcining, to prepare a denitration catalyst.

The denitration catalyst was instantaneously immersed in an aqueous solution containing KOH and Ca(NO₃)₂, followed by calcining at 400° C. for 3 hours to prepare a simulated alkali-deteriorated catalyst. The catalyst was immersed in various acid aqueous solutions as a washing solution for 5 hours, and the dissolution property of K and Ca, which were deteriorating components, was measured. The results are shown in FIG. 6. It is understood from FIG. 6 that the dissolution property of an alkali substance depends on pH of the washing solution irrespective to the kind of the washing-solution, in which immersion in a washing solution having low pH dissolves almost the entire alkali substance.

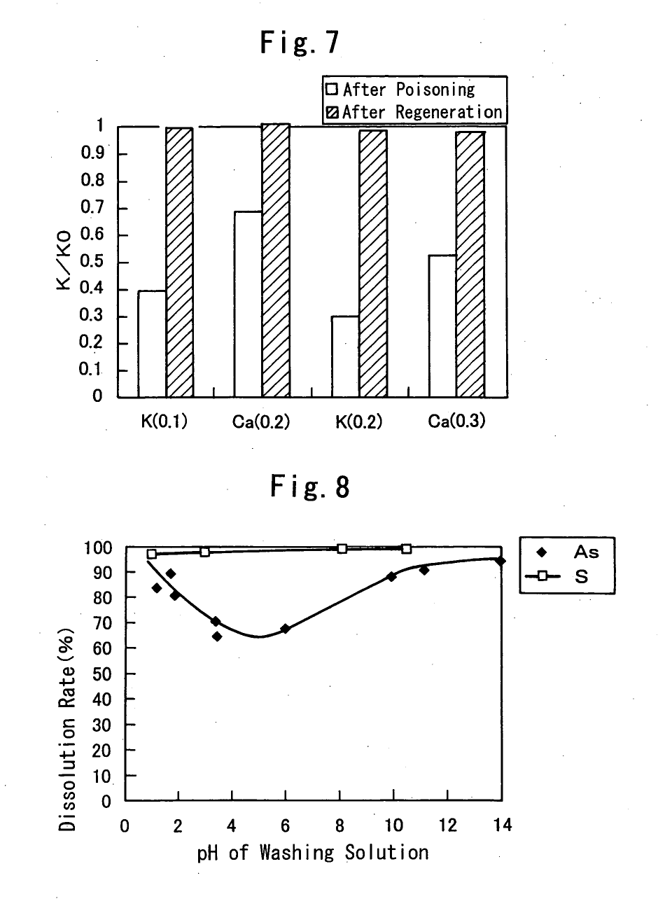

Subsequently, a standard denitration catalyst was measured for initial activity, and it was subjected to poisoning with K and Ca aqueous solution, respectively, and then measured for activity. Furthermore, it was immersed in a nitric acid aqueous solution having pH of 1.3 for 5 hours and then immersed in an NH₃ aqueous solution having pH of 10.5 for 5 hours to dissolve and remove away vanadium oxide and tungsten oxide, and then vanadium oxide and tungsten oxide were deposited thereon under the same conditions to regenerate the alkali-deteriorated catalyst, followed by comparing in performance. The results are shown in FIG. 7. It is understood from FIG. 7 that the performance is substantially restored to the initial performance. In FIG. 7, numerals in parentheses are concentrations of K or Ca in the immersion solutions (mol/L).

The performance of a catalyst is defined by the ratio K/K₀, in which K represents the reaction rate constant at 350° C. of the assumed first-order reaction where the ratio NOₓ/NH₃=1.0 (K=−(AV)ln(1−x), wherein x represents the denitration rate), and K₀ represents the performance of a fresh catalyst.

### (2) Regeneration of Arsenic-Deteriorated Catalyst

Vanadium oxide and tungsten compound were deposited on a plate carrier under the same conditions as above to obtain a standard denitration catalyst.

The catalyst was exposed to air containing arsenic oxide vapor in an amount of about 25 ppm in terms of As at 350° C. for 4 hours for deterioration of performance to prepare a simulated arsenic-deteriorated catalyst. The catalyst was immersed in various acid aqueous solutions as a washing solution for 5 hours, and the dissolution property of As, which was a poisoning substance, was measured. The results are shown in FIG. 8. It is understood that the dissolution property of an arsenic substance depends on pH of the washing solution irrespective to the kind of the washing solution, in which immersion in a washing solution having low pH dissolves almost the entire arsenic.

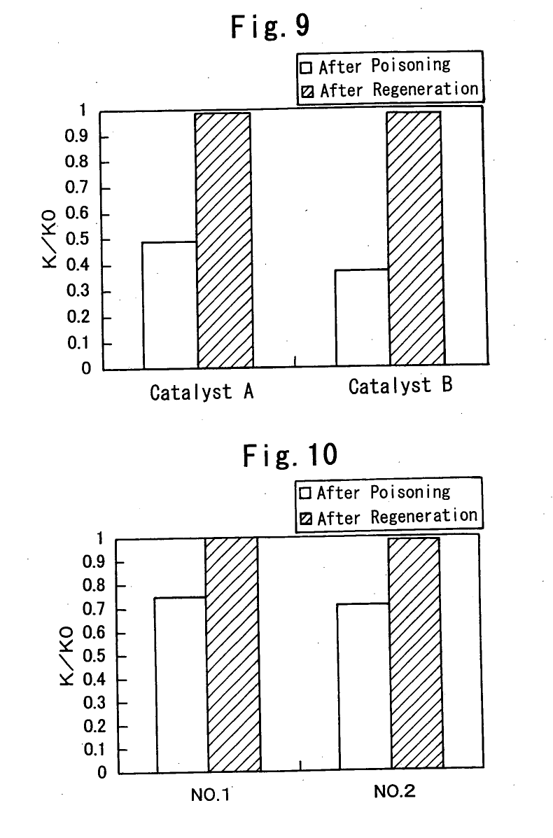

Subsequently, the standard denitration catalyst was measured for initial activity, and it was subjected to poisoning by exposing to the aforementioned arsenic vapor for 4 hours (catalyst A) or 6 hours (catalyst B), and then measured for activity. Furthermore, it was immersed in a nitric acid aqueous solution having pH of 1.3 for 5 hours and then immersed in an NH₃ aqueous solution having pH of 10.5 for 5 hours to dissolve and remove away vanadium oxide and tungsten, and then vanadium oxide and tungsten oxide were deposited thereon under the same conditions to regenerate the arsenic-deteriorated catalyst, followed by comparing in performance. The results are shown in FIG. 9. It is understood from FIG. 9 that the performance is substantially restored to the initial performance.

### (3) Regeneration of Actively Deteriorated Catalyst

A catalyst having been deteriorated in performance by using for denitration of a coal-burning exhaust gas for a long period of time was measured for activity. The catalyst was then immersed in a nitric acid aqueous solution having pH of 1.4 for 5 hours and then immersed in an NH₃ aqueous solution having pH of 10.5 for 5 hours, and then vanadium oxide and tungsten oxide were deposited thereon under the same conditions to regenerate the deteriorated catalyst, followed by measuring restoration of performance. The results are shown in FIG. 10.

The performance could be substantially restored to the initial performance by washing with an acid and an alkali and re-depositing an active component thereon.

In FIG. 10, No. 1 and No. 2 show catalysts applied to different kinds of coal-burning exhaust gas.

### (4) Compression Strength

The compression strengths of the catalyst before and after the catalyst regeneration shown in the item (3) for the regeneration of the actively deteriorated catalyst are shown in Table 2. It is understood from Table 2 that no decrease in compression strength is found after the catalyst regeneration. In Table 2, the compression strength ratio is a ratio (compression strength after regeneration)/(compression strength before regeneration).

TABLE 2
(Compression Strength Ratio)

| Coal-burning exhaust gas | |
|---|---|
| system | Compression strength ratio (−) |
| No. 1 | 0.97 |
| No. 2 | 0.98 |

### COMPARATIVE EXAMPLE 1

### Regeneration of Actively Deteriorated Catalyst

Regeneration was carried out in the same manner as in the item (3) of Example 2for the regeneration of the deteriorated catalyst except that the order of the washing operations with an acid and an alkali in the item (3) of Example 2 was inverted.

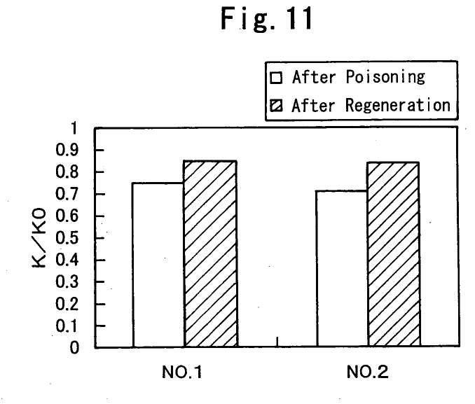

That is, a catalyst having been deteriorated in performance by using for denitration of a coal-burning exhaust gas for a long period of time was measured for activity. The catalyst was then immersed in an NH₃ aqueous solution having pH of 10.5 for 5 hours and then immersed in a nitric acid aqueous solution having pH of 1.4 for 5 hours, and then vanadium oxide and tungsten oxide were deposited thereon under the same conditions to regenerate the deteriorated catalyst, followed by measuring restoration of performance. The results are shown in FIG. 11.

It is understood from FIG. 11 that when the order of the washing operations with an acid and an alkali was inverted, the regeneration effect is clearly low as compared to Example 2, and the performance is restored only to about 85% of the initial performance.

### INDUSTRIAL APPLICABILITY

The invention provides a method for regenerating a thermally deteriorated catalyst, and a method for regenerating a deteriorated catalyst that is used for reduction removal of NOₓ in a coal-burning exhaust gas by using ammonia and has been deteriorated. The method of the invention enables regeneration of a thermally deteriorated catalyst, which has conventionally been impossible.

1. A method for regenerating a thermally deteriorated catalyst characterized by comprising steps of washing a catalyst that is used for reduction removal of NOₓ in a exhaust gas by using ammonia as a reducing agent and has been deteriorated in activity by aggregation of vanadium oxide as an active component through long term use at a high temperature with an acid aqueous solution having pH of 6 or less, so as to dissolve and remove away mainly vanadium oxide as an aggregated active component; and then re-depositing vanadium oxide as an active component thereon.

2. The method for regenerating a thermally deteriorated catalyst as claimed in claim 1, characterized in that nitric acid or hydrochloric acid is used as the acid.

3. A method for regenerating a thermally deteriorated catalyst characterized by comprising steps of washing a catalyst that is used for reduction removal of NOₓ in a exhaust gas by using ammonia as a reducing agent and has been deteriorated in activity by aggregation of vanadium oxide as an active component through long term use at a high temperature with an alkali aqueous solution having pH of 8 or more, so as to dissolve and remove away mainly vanadium oxide and tungsten oxide as an active component; then re-depositing titanium oxide as a carrier component thereon; and then re-depositing vanadium oxide and tungsten oxide as an active component thereon.

4. The method for regenerating a thermally deteriorated catalyst as claimed in claim 3, characterized in that aqueous ammonia is used as the alkali.

5. A-method for regenerating a deteriorated catalyst characterized by comprising steps of washing a catalyst that is used for reduction removal of NOₓ in a coal-burning exhaust gas by using ammonia as a reducing agent and has been deteriorated in activity with an acid aqueous solution having pH of 4 or less, so as to dissolve and remove away mainly an alkali metal, an alkaline earth metal, arsenic and sulfur, which are deteriorating components; then washing with an alkali aqueous solution having pH of 8 or more, so as to dissolve and remove away mainly vanadium oxide and tungsten oxide as an active component; and then re-depositing vanadium oxide and tungsten oxide as an active component thereon, followed by calcining.

6. The method for regenerating a deteriorated catalyst as claimed in claim 5, characterized in that a water washing step is inserted among the acid treating step, the alkali treating step and the active component re-depositing step.

7. The method for regenerating a thermally deteriorated catalyst as claimed in claim 5, characterized in that nitric acid or hydrochloric acid is used as the acid.

8. The method for regenerating a thermally deteriorated catalyst as claimed in claim 5, characterized in that aqueous ammonia is used as the alkali.
